(19) United States
(12) Patent Application Publication
(10) Pub. No.: US 2008/0302233 A1
(43) Pub. Date: Dec. 11, 2008

(54) Digital music systems

(76) Inventors: Xiao-Yu Ding, Union City, CA (US); Frederick Ho, Union City, CA (US); Helen Ho, Union City, CA (US); Jacquelin Ho, Union City, CA (US); Sharon Liu, Hayward, CA (US); Pu Zhang, Beijing (CN)

Correspondence Address: FISH & RICHARDSON, PC, P.O. BOX 1022, MINNEAPOLIS, MN, 55440-1022, US

(21) Appl. No.: 12/072,804

(22) Filed: Jan. 3, 2008

Related U.S. Application Data
(60) Provisional application No. 60/878,145, filed on Jan. 3, 2007.

(51) Int. Cl. G10H 7/00

(52) U.S. Cl. 84/609

(57) ABSTRACT

Digital music systems, apparatus and techniques based on digitized music data and information to allow for a wide range of applications including digital music practice companion systems.

### PRIORITY CLAIM AND RELATED APPLICATION

This application claims the benefit of U.S. Provisional Application No. 60/878,145-entitled “Intelligent, effective music education system” and filed on Jan. 3, 2007, which is incorporated by reference as part of the specification of this application.

### BACKGROUND

This application relates to digital music systems, apparatus and techniques based on digitized music data and information.

Music can be digitized for manipulation of the music, for transmission and transport of the music, for playback of the music and for storage of the music. Electronic musical instrument such as electronic keyboards can transform playing of the instrument by a person into digital data and sound. One widely adopted standard is the Musical Instrument Digital Interface (MIDI), an industry-standard protocol that enables electronic musical instruments, digital processor and computers and other equipment to communicate, control and synchronize with one another. MIDI transmits digital data that represents the music (e.g., a song) such as the pitch and intensity of musical notes to play, control signals for parameters such as volume, vibrato and panning, cues and clock signals to set the tempo.

MIDI has been used in various digital music applications including digital music training systems. See, for example, U.S. Pat. Nos. 6.6,751,439, 6,072,113, 5,955,692, and 5,952,597.

### SUMMARY

This application describes, among others, examples and implementations of digital music systems, apparatus and techniques based on digitized music data and information to allow for a wide range of applications including digital music practice companion systems.

In one aspect, a computer-implemented method for digital music includes dividing information in a music piece into a plurality of music aspects that comprise note pitch and duration for one or more voices, tempo, dynamics, phrasing, articulation, and fingering of the music piece; obtaining digital data of the music aspects of the music piece, based on at least one of (1) definitions and intentions of a composer of the music piece and (2) interpretations and modifications of the music piece by a selected person, to generate reference data for the music piece; obtaining performed data of a player playing the music piece on a digital music instrument; comparing the performed data to the reference data to produce a comparison result; and producing a digital output representing the comparison result.

In another aspect, a digital music system includes a reference database to store digital reference data of music pieces. The reference data for each music piece comprises data on a plurality of music aspects that comprise note pitch and duration for one or more voices, tempo, dynamics, phrasing, articulation, and fingering of the music piece. The system also includes a user database to store performed data of one or more players playing music pieces on digital music instruments; and a comparison module that compares performed data of a player playing a player-selected music piece to corresponding reference data for the player-selected music piece to produce a comparison result in form of a digital output representing the comparison result.

These and other implementations and examples of the apparatus, systems and techniques are described in greater detail in the drawings, the detailed description and the claims;

### BRIEF DESCRIPTION OF DRAWINGS

FIG. 1 shows an example of how a music piece is being split into different aspects which are assembled together to generate an accurate, scalable, and customizable description of the music piece.

FIG. 2 shows an example of how music word is formed for the given two measures of a music piece.

FIG. 3 shows an example of a digital music system with various system modules and data flows.

FIG. 4 shows the administrator user's workflow to upload, validate, modify, and make a standard reference music data live so that all end users can find and use the standard reference data.

FIG. 5 shows an example of a MID roll output format showing how to customize the measure, voice of a music piece to listen to, where the user drags the long scroll bar to the desired measure, and use the volume control widget for each voice to control how much of that voice will be heard, and where the user subsequently clicks the Listen button, which will turn itself to the Stop button after the listening session starts.

FIG. 6 shows an example of an intelligent music sheet output format for a music piece with multiple voices with each voice in its own color.

FIG. 7 shows how reference data is searched and browsed by end users. All the composer, instrument, and style entries are clickable and will narrow the results to those entries matching the selected link.

FIG. 8 shows an example showing how a sequence of user performed data with note ABCDE is rearranged in the preprocess module to the new order of ADCBE.

FIG. 9 shows an example of performance data displayed in MIDI roll style.

FIG. 9A shows an example of summary information about a music piece followed by a discussion thread about the piece.

FIG. 10 shows an example of levels of users in the system and functions supported for different levels of users.

FIG. 11 shows an example of a workspace snapshot for a user.

FIG. 12 shows an example of the multi-pass comparison to resolve a potential false alarm.

FIG. 13 shows an example of how Customized Reference Data, which reflects each user's own interpretation of music, is derived from the Standard Reference Data, which precisely describes composer's intension.

FIG. 14 shows an example for the text summary of an analysis result.

FIG. 15 shows an example of the midi roll version of analysis result.

FIG. 16 and FIG. 17 show sheet music version of analysis result.

FIG. 18 shows an example of a text based simple practice suggestion.

FIG. 19 shows a music piece with relatively complex rhythms.

FIG. 20 shows the same piece of music in FIG. 20 that is being transformed into a piece for rhythmic practice purpose.

### DETAILED DESCRIPTION

Examples and implementations of digital music systems, apparatus and techniques described in this document use digital information captured from a music composition to include music attributes or aspects that are beyond the digital information in MIDI files. The additional information from the music composition can be used to provide a wide range of applications, some of which are illustrated in specific examples in this document.

In one aspect, a digitization process that generates reference music is used to precisely describe the music piece to be performed and to separate different music aspects, such as note pitch and duration for different voices, tempo, dynamics, phrasing, articulation, and fingering of music piece so that with the exception of required presence of note pitch and duration section, each can be defined independent of others and each can be used independent of others to generate reference data for comparison between the reference data and data representing the playing of the music by a user (e.g., a student or a performer). For example, the digitization process can assign each pitch a unique value, which after dividing the music by measure or by phrase, turns a music piece into many music words that can be indexed and searched. The digitization process allows easy additions of different interpretations and modification later on, that can be converted to other music formats including audible formats and format that is used as the base of comparison algorithm of this practice companion system, that is used as the base to render reference music in accurate sheet music form, in intelligent sheet music score form with notes in each music voice in its own color or shape, and in highly accurate midi roll style form.

Based on the digital information form the above process, an interactive module for selected users, such as administrative or experienced users, can be provided to upload one or multiple reference music pieces onto the server system through a web base user interface, to parse and validate the reference music content, to add the reference music piece into the live digital sheet music repository that is visible to all end users.

A user interface module can be provided to enable browsing reference music repository by various search parameters, such as by composer, by instrument, by category, and by collections and therefore, enables searching through one or more collections of digital reference music pieces based on the song title, composer, instrument, category, collection name, and key and selecting a desired piece to play, to study or to listen to.

A user interface module can also be configured to enable users to listen to complete music pieces, specific sections of music pieces, and specific voices of music pieces that are generated from standard or customized reference music data, or performed before by individuals including the current user.

An intelligent and dynamic sheet music rendition can be configured to display note head for different voices in different colors or note head for different voices in different shapes, that can be configured to display different levels of interpretations and complexities, than can be extended to display immediate and straight forward explanations for music symbols. A unique midi roll rendition of music piece, with note pitch, duration, and volume displayed, with objects rendered in transparent mode so they will not obscure other objects, with real time automatic scrolling when the song is being practiced or listened to, or user initiated scrolling to view different sections of music, and with the capability of rendering different voices in different colors or shapes. Both forms of renditions have vertical and horizontal layout styles.

A user interface module can be provided to enable users to submit and view history, recommendation, different approaches, users' discussion, and comments for reference or performed music pieces.

A system based on the above digital features can be configured to provide different user levels so that certain features can only be accessed by selected users with certain levels while excluding other users from access. Such user selective restrictions can be extended to support permissions, roles, and groups to enables users to establish relationships between them, to have features granted to certain permissions, roles, and groups.

A user interface module can be designed to enable users to view, manage, and share their own or others' workspaces, progress chart, performance, and practice history.

A client based module can be designed to record players' rendition of music pieces, uploads such rendition to the system server for preprocessing and analysis. A server based preprocess module can be provided to rearrange the performed note sequence so that when multiple performed notes have the same starting time, lower pitch notes are arranged before higher pitch notes in the time based sequence; when the starting time of two notes are very close and their duration are not short compared to the difference between their starting times, the two notes are treated by the system as being in one chord or being played at the same time thus will have the lower pitch note before the higher pitch note even if the lower pitch one might have a slightly later starting time.

In one implementation, conversion modules can reside on the server side to convert reference music pieces built through the present digital process to internal time based sequences to conduct comparison. When multiple reference notes have the same starting time, lower pitch notes are arranged before higher pitch notes in the time sequence. Individual entries in both reference data sequence and performed data sequence contain pitch, duration, and strength information. Reference data entry also has voice and measure information. Reference data sequence can be cached to improve performance. Reference data sequence can also be dynamically regenerated again after omitting, including, or customizing some aspects of referencing data, after changing the music such as changing the pitch of a note or adding crescendo to a passage, changing the interpretation of the reference music, such as changing how trills are executed, changing preferred speed for a specified tempo, or changing preferred strength for certain dynamics.

An analysis module can be provided to compare data performance data captured from a user in the internal format and referenced data in the internal format. Such comparison can be conducted via multiple full pass comparisons with the first pass comparing notes in all voices to determine performed notes' rough location, and later passes comparing one voice only unless there is a small set of notes left. Such multiple full pass comparison can be used to eliminate false alarms from intentional deviation in performance by the user, for example, when there is a rubato, or unintentional slight off sync of multiple voices. The module analyzes one or multiple performed renditions of one music piece to its reference digital music in the repository, generates results including differences in all aspects, differences in selected aspects or selected sections, specified by users, measures with most errors in one play, and repeated errors in multiple practices of the same music piece. It can be extended to ignore errors at specific locations or errors of specified types. It can also be extended to processes player's previous practices to find out improvement made and problems remains. The module resides on the server side now but can be moved to the client side, along with reference data and conversion modules, for potentially quicker response time.

A client based display module that takes analysis result data from the above comparison analysis can be provided to display results in summary and detailed text description, in sheet music form with mistakes and areas need attention highlighted, or in accurate midi layout form with notes, dynamics, mistakes and areas need attention displayed, which is visualized on a computer screen. Such display can be maneuvered though the user interfaces for easy and quick identification of errors by sync up other displays' position when the current display's error gets the input focus, and by allow the going to the next problematic measure with a single user input. The module can be extended to be on an electronic device with display,

A recommendation module can be used to provide practice advices to a user in text format based on analysis results. The function can be extended to display advices on top of sheet music form or in midi layout form.

The above features can be used to provide a real time audio and visual practice coaching thread, reminding users of upcoming dynamic, tempo, phrasing, other changes, and previous mistakes.

In another aspect, an intermittent metronome, where the sound of the metronome is alternatively turned on and off automatically for users who want to practice their own control of tempo without the help of a metronome for most of the time, yet still want to be checked intermittently to see if they are deviating away from the correct tempo or not. The duration for metronome on and off time is defaulted or user specified. It can also be extended to be turned on only when users are off the tempo. The system can also be extended to support the metronome to be adaptive to the reference music's change of tempo and time signature, and to be adaptive to a user's preset change of tempo. Special attention can be given to time signature and rhythm so that the metronome sounds can remind user which beats should be emphasized.

Various features described in this document can be used to transform a regular reference music piece into a reference rhythmic practice piece by collapsing multiple notes in a chord in each voice into one note, by changing all notes in each voice to have one unique pitch that is different from other voices, by ignoring dynamics, phrasing, and articulation embedded in the original reference piece. The rhythmic training result can be evaluated based on the comparison analysis between the user's performance data and the reference data to provide an accurate comparison of a reference note and its matching performed note's start time and duration and an evaluation measure by measure to see if in the performed data, the right beats have the emphasis or not.

In another aspect, a virtual playing module can be provided based on network socket programming to establish communication and data transferring between two or more users or multicast data from one user to multiple users, to show remote users with digital music instruments exactly what was played by users, teachers, or masters from a remote location in near real time with minimum delay. In one implementation, for example, the participants are not required to physically meet at a location. The performance data can be uploaded to the system server so the uploaded data can be replayed to be observed at a later time. There is no formal teacher-student relationship for the case when a student just needs occasional advice. The system can be extended so that teachers' time can be purchased or bid online. This gives users access to great teachers as well as those at affordable price. Remote e-concert or master class and performance are also enjoyed and observed by wide audience without physically going to the class location.

In another aspect, the system can be extended to be switchable between regular practice checked mode and practice not checked mode. In the practice not check mode, user's practice time is still accumulate yet the performance is not graded. It gives the user a chance to quickly try out some non-standard approach or repeatedly practice some passages without the risk of lowing the user's grade. The system can be extended to have free practice mode, when students can practice any music pieces they desire with minimum interaction with computer. The user will not need to specify the music piece being practice, nor does the user need to specify the start and the ending of the music practice. The system will automatically record every note played, identify songs or sections of songs played, grade them, and record breaks taken between practice as well as total practice time.

The system can also be extended to support practicing at lower speed but speed it up during playback so the user can hear and anticipate what his/her playing eventually will sound like. The system can be extended to combine tedious music practice/drill with games and animations.

The system can also be used to support accompaniment by playing accompaniment data from reference or user data repository, or from remote performance.

In yet another aspect, the system can be extended to automatically enhance performed data by removing identified extra notes in the performance data and adding missed reference data into the performed data, by setting the strength of performed notes to the desired value specified in the reference note, by removing unwanted gap in the practice data and adjusting a note start time and duration when tempo around it is off.

Instead of using buttons in the web based user interface to control starting, ending, canceling recording of the practice and other functions, special combinations of notes that usually do not appear in a music piece can be used as the hot keys to issue those commands. An example will be using three consecutive play of the lowest note on the instrument to mark the beginning of practice. Play the same sequence will end the practice. Play the highest note on the instrument three times will cancel the practice.

As alternative to the web-based configuration, the system can be configured as installed software product on one or more computers, or combination of software installation on computers and web-based support and interface.

The aforementioned and other features described in this document can be used to provide user adaptable practice companion systems for music students to enhance daily practice.

Music students usually follow their daily practice schedule. Some students tend to repeat the same mistakes practice after practice without realizing it until the next session with the music teacher. This is a waste not only of practice time but also instruction time since the teacher will have to spend a lot of time correcting fundamental mistakes. Music practicing is often done isolated, especially for solo instrument. The systems described in this document can be used to make practice much more efficient and enjoyable.

MIDI based music data is inherently not flexible, not accurate, and usually cannot reflect various intentions from a composer. For example, to change a passage's dynamics in a MIDI file, all notes' volume in the passage will need to be changed. For a note with duration about 1/32nd length, there is no definite answer if it is indeed a 1/32nd note or just a staccato sixteenth note. Trills are already expanded so they cannot be interpreted differently. It can be difficult for an end user to modify or customize a MIDI based referenced data to reflect the user own interpretation of the music. Also there is no voice information unless each voice is recorded in its own channel. Measure information may be derived when the note start time and duration information are recorded accurately in the MIDI sequence. The techniques described in this document can be used to remove such rigid restrictions associated with MIDI files.

MIDI version of music tends to exhibit poor sound quality on a computer. A system based on the present techniques in this document can be configured to provide high quality in playback to better exhibit the original music to a student.

A system based on the present techniques in this document can be configured to provide midi roll style rendition of performance to accurately display performed or reference data.

In addition, with few exceptions, many systems are CD based so that the programs come with limited amount of reference data. Although it possible to download MIDI songs from internet and then add the new data to those programs, many students find the process too troublesome, especially when the quality of those MIDI data is not guaranteed. The features described in this document can be used to mitigate such issues.

The features described in this document can be used to provide the capability of modifying reference data as part of the systems to support multiple music interpretations because many music teachers and experienced musicians have their own approaches for dealing with the same music passage.

An example of a Music Practice Companion System is described below for accompanying music students through their daily practice ritual. This example is used to illustrate various features in this document. The system can be used to make practice more efficient for music students. With the help of this highly accurate companion system, even obscure mistakes made while practicing complicated music pieces at fast speed are accurately pointed out and corrected. Students then go to instruction sessions with their regular music teachers much better prepared, and teachers can spend more time teaching more important matters such as the nuances of a piece and critical techniques. The system is computer, internet, and web user interface based. It is designed to be accurate, effective, open, non-intrusive, with minimum user interaction needed, feature rich yet simple to use.

This companion system's reference data contains artistic intentions marked by the composers. The reference data precisely describes the music piece to be performed in abstract forms instead of embedding music information into each individual note. So changing a passage's dynamics can be as simple as changing from “mf” to “f”. There is no ambiguity involved if a note is clearly marked as staccato. And music expressions and articulations can be executed in different ways when generating internal representation of the reference data as long as the interpretation is reasonable.

This companion system can be designed to be as less intrusive and as simple to use as possible. It utilizes the computer's power yet keeps users' interaction with the computer to minimum so that attention is on music practicing instead of how to use the computer program.

The system can be designed to be accurate in presenting information on the music and to support customization of standard reference data by taking into, account of details such as rubato and different ways to executing a trill, so that even obscure mistakes made while practicing complicated music pieces at fast speed are accurately pointed out while no false alarms are generated.

Performance from the current user, from other users, and from that generated off reference data is sent to the digital music instrument connected to the client computer first, or in case that fails, is converted to popular digital audio formats with high quality sound fonts for users to listen.

The system can present sheet music in high quality using one of the best existing music score rendering technology and provides intelligent sheet music, where each voice can have its own presentation, and an animated MIDI roll display to show data accurately.

In one implementation, central services can be updated and reference music pieces can be added to the central music repository by experience users or the system administrator and then become available to all users. So there is no need to upgrade software or download reference data.

In this system, teachers can easily alternate the standard reference version to reflect their interpretation of the music, and keep the version as a private reference version for their students or make available to other audiences as well. This open approach adds great flexibility and usability to the system.

The end user hardware configuration this practice companion system depends on is made up of a digital music instrument or a digital device added to an acoustic music instrument, which is capable of outputting digitized music performance data, a cable or a wireless device to pass the music performance data over to a computer with internet connection. The performance data is recorded by the practice companion system's client side program, uploaded to the system's central server through internet, being processed and analyzed. The result is then sent back to the client computer and rendered by the client display module.

To use the system, users simply turn on the digital music instrument and the computer that are connected with a proper cable or wireless device, and log on to the designated web site, pick the desired music piece from the system's repository, start practicing, and view their practice result.

From the web site, users also have access to a rich set of other features if desired. They can browse or search through a repository of high quality sheet music, listen to specific measures of a piece played to their digital music instrument, play the music piece themselves and have the performance analyzed, catch specified or all mistakes made in that particular performance, have repeated mistakes pointed out after practice the same piece multiple times, have actual play time captured, have all practice data recorded and archived automatically, share their current or best performance with friends and within the web based music community, observe from their own homes renditions performed by their peers, teachers or masters located remotely, have user's own performance converted to popular digital audio formats with high quality sound fonts, and download their own performances.

With the help of this computer and internet based, accurate, effective, easy to use, open, feature rich yet simple to use practice companion system, students can go to instruction sessions much better prepared, and teachers can spend more time teaching on more important matters such as the nuances of a piece and critical techniques.

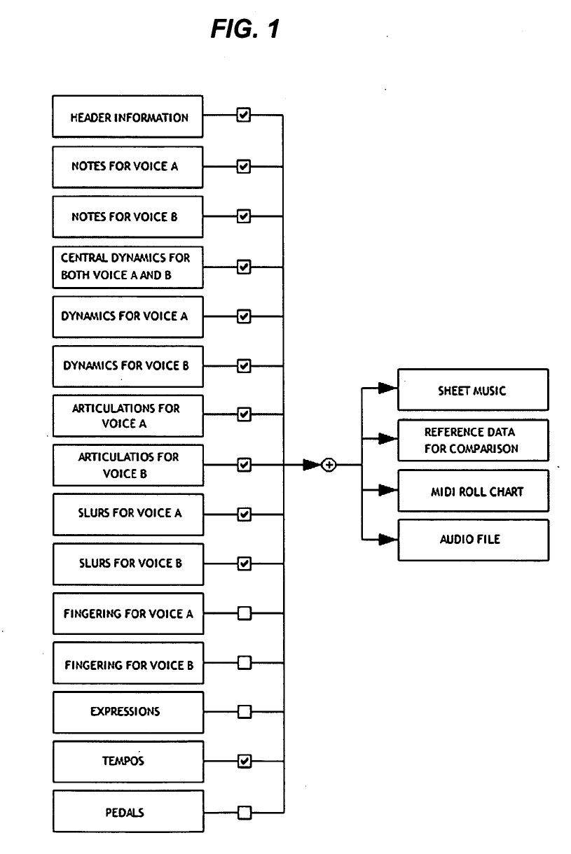

FIG. 1 shows an example of various music attributes or aspects of a music piece that can be defined and captured separately, and then assembled together to generate an accurate, scalable, and customizable description of the music piece. In this particular example, the music piece has two voices A and B and examples of various aspects of the voices A and B are shown. For example, the central dynamics of A and B includes the common dynamics features of the two voices A and B; the header information include the title of the song, the composer information and key information and others. The digital data on these different aspects is separated captured or entered into the system. The system can select some or all of the captured aspects of the music to generate a desired output: a digital sheet music showing on a display, reference data for comparison with a user's performance data or other data, a MIDI roll chart, or a digital audio file for playback.

The music digitization process that generates reference data precisely describes the music piece to be performed. As an example, first, each note's pitch value and time duration are defined based on the time sequence. The exact starting point, of notes, dynamic changes, rhythm changes, slur, and pedal are determined in terms of how much time, that is how many whole, half, quarter, eighth, sixteenth, thirty-second, and sixty-fourth notes, has already passed from the beginning of the music piece to the current music symbol. The ending point, when applicable, is based on starting point plus the current symbol's duration, or how much time has already passed if the symbol is ending its matching starting pair. Information such as exact tempo and volume may not be tied up to each note or embedded in each note, and may not be associated with any absolute value other than the position of the music sign or the music term itself.

One characteristic of the digitization process is that aspects of music are defined independent of each other so that the definition of one aspect usually does not rely on definition of other aspects. Pitches and durations for each voice are defined in its own section, which is the only required element for a voice that must be defined. All other aspects are optional and can be defined in a desired order. Each voice has its own dynamic change section. Multiple voices may have their combined dynamics section.

For example, consider four voices A, B, C, and D in a song where each voice may have, but don't have to have, its own dynamics: ADynamics, BDynamics, CDynamics, DDynamics, respectively. Two or more voices may have combined dynamics. E.g: ABDynamics for voice A and B, CDDynamics for voice C and D, and ABCDDynaics for all voices. Similarly, each voice has its own section for phrasing and legato. Similarly, each voice has its own articulation section for staccato, accent, and other marks. Similarly tempo change is defined in its own section. Similarly pedal has its own section.

Similarly technical guidance related information such as fingering has its own section. Fingering can be extended to be separated into different levels of details: no figuring, critical fingering, detailed fingering, and all fingering.

Some or all of above sections, which are determined by users and cannot conflict with each other, are picked to generate sheet music of different levels of details.

Each voice may be represented by its own colors or shapes in the display to the user. Similarly, some or all sections are picked to generate reference version of music in audio format, again where each voice has its own distinct characters such as lower/higher volume if the defined value is not desired. Similarly, some or all sections are picked to be used as a reference to analyze the user's rendition of a music piece.

The system can be extended to support location based reference data to support different languages used at different locations such as different countries. Fields that have different values for different languages can be extended to be tagged with file names, where the translations for the fields are stored, and keys for retrieving values for the fields out of the files for the desired language. When translation file or entry specified by the key for the desired language is no available, string value for default language can be used instead.

The digital format can include the following header fields: composer, category (fugue, invention, mazurka, piano concerto, prelude, sonatina, sonata, symphony, and violin concerto), title, period (baroque, classical, romantic, and modern), genre, instrument, key, time signature, opus, number, movement number, level, and publish date.

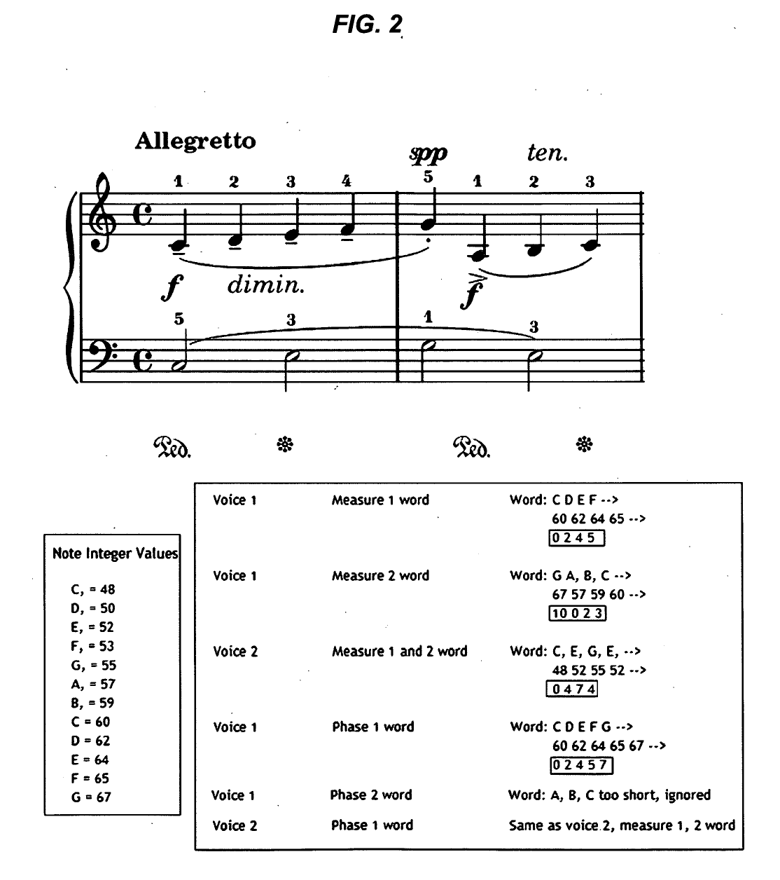

A music piece can be turned into text like words as shown in FIG. 2. The transformation into a string of words can starts with assigning each pitch a unique value. The lower pitch note has lower value, and higher pitch has higher value, with each increase of half tone/step corresponds to one unit of value increase.

An example is the middle C note has value 60, middle C sharp has value of 61, and B right below middle C has value of 59. Rest, silent rest, ornament notes are treated like null character and are ignored. So each music note in a music piece except rest has its corresponding value that can be viewed as a music character. Then music characters are grouped by measure and by phrase to form music words. The starting note of a measure or a phrase is the first character in the music word. The rest of characters of the word are ordered based on their start time in the measure or phrase. Notes in the same voice form one word. So if a measure or phrase contains multiple voices, multiple music words will be formed. In addition, all notes in all voices form another word. This is to take into account of cases where melodies are formed by multiple voices. For the case where there is a chord, when there are more than two notes in the chord, the middle notes are discarded. Then two words are formed, with one word consists of regular notes not in any chord, and chords' top notes. Another word is formed with regular notes not in any chord plus chords' bottom notes. The minimum length of a music word can be set to be four. When a measure base word is shorter than four, the next measure's notes are borrowed. Next measure is also included while forming words if all notes are the same in current measure but when more than eight notes are the same consecutively, notes in current measure and voice are discarded. No phrase based word is formed when the phrase contains less than four usable notes in the voice. Measure based words and phrase based words are independent of each other.

A note can appear in a phrase based word in addition to a measure based word. While the span of a measure is very obvious, the span of a phrase is determined by beginning and ending of a slur. An artificial phrase section for a voice, which is not presented in sheet music, with the sole purpose of forming music word, can also be added to the reference music data by creating a section for the voice with appropriate time durations, phrase starting symbols, and phrase ending symbols.

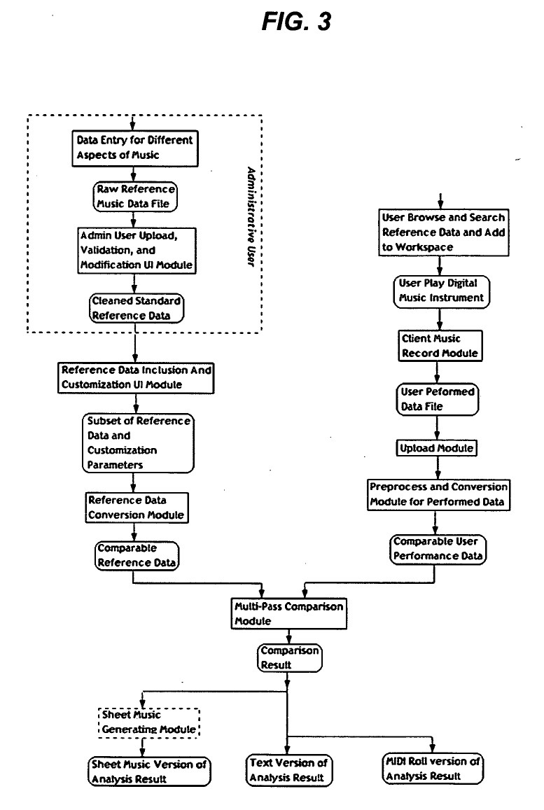

FIG. 3 shows an example of a digital music system with various system modules and data flows. There are two sources of data: the reference data, which is the left hand flow in FIG. 3 and represents the precise description of a music piece, the performed data, which is the right hand side flow in FIG. 3 and represents user's rendition of the music piece which needs to be analyzed. The processing engine is the multi-pass comparison module that receives the performed data and the reference data and performs multi-pass comparisons to produce a comparison result. This comparison result can then be used to generate a desired output which may be in any one or more of available output formats such as the sheet music output, the text output and the MID roll output.

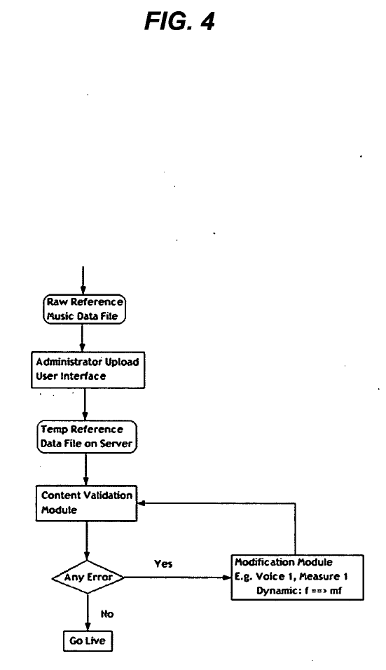

FIG. 4 shows a process for bringing the reference data into the system in FIG. 3. An upload user interface is used to update the raw reference music data file to produce temporary reference data file to be stored on the server. A content validation module processes the temporary reference data file to produce a final reference data file to be used in the system as indicated by “Go live” box in FIG. 4. An error detection and correction process loop is provided to correct any error in the temporary reference data.

Once the reference data is entered following above process and stored in a file, a web based user interface is used to let the user specify the local file's location, then upload the local file to the server side. The server system parses and validates the content. The validation module checks for invalid header fields, invalid note sections, too many or too little notes in measures for a given time signature. Where there is a format or content error, the error is flagged. The piece is flagged as in validation error state. The error is corrected by user offline, saved to the data file, and is uploaded into the system again. When no error is found during the parse and validation stage, the piece is in ready to go live state. Error can also be correctly online through the content modification screen.

Reference data, and user performed data, can be viewed online. The content viewing part of the user interface (UI) can be shared between administrative users and end users. Header information of the piece is viewed in the summary page.

As one output option shown in FIG. 1 and FIG. 3, the content information can be viewed in a midi roll format, with the position of a bar indicates the pitch of the note, the length of a bar indicates the length of the note played, and the position of a bar indicates the starting and ending time of the note played.

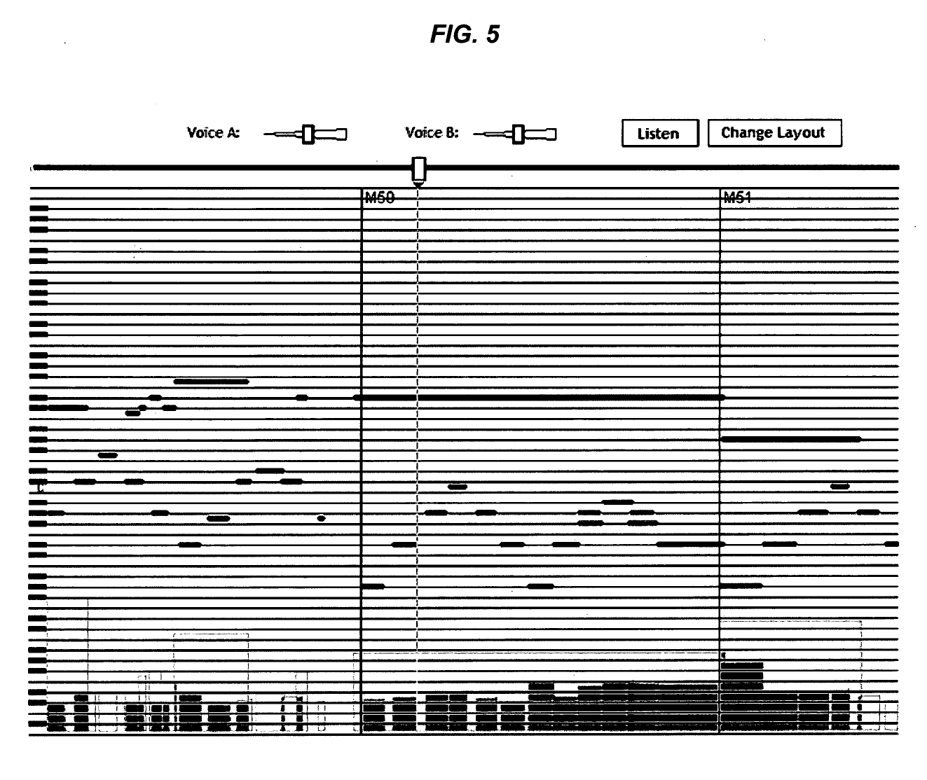

FIG. 5 shows one example of the midi roll format output and shows how to customize the measure, voice of a music piece to listen to. The user drags the long scroll bar to the desired measure, and use the volume control widget for each voice to control how much of that voice will be heard. Then click the Listen button, which will turn itself to the Stop button after the listening session starts

The volume is drawn near the bottom of the screen as a separate bar with the height indicates its intensity. Bars for notes and volume are drawn in transparent mode, so notes and volumes drawn earlier are not to be covered by later drawn notes and volumes. Beginnings of measures are indicated by thin lines along with measure numbers in text. The graph can be dragged to scroll in the dragged direction, or be scrolled using a scrollbar. Click on the graph will stop the scrolling. Users can drag the starting tag to any part of the song and listen to the piece from the starting tag.

Pedals can be displayed on the screen similar to regular notes, but with its own distinct color or texture. Other music articulations are usually reflected by the note's own position, length, and strength. The midi roll display is usually in horizontal orientation, with pitches drawn on the left and the time axis goes from left to right. The midi roll display can also be displayed in vertical orientation, with pitches drawn on the top or bottom, the time axis goes from top to bottom.

Another output option renders the music piece in an intelligent digital sheet music format, which is separately by itself but can be extended to be along and in sync with the midi roll style rendition. A change in position in one rendition can immediately synchronize with other renditions to the same position for easy comparison.

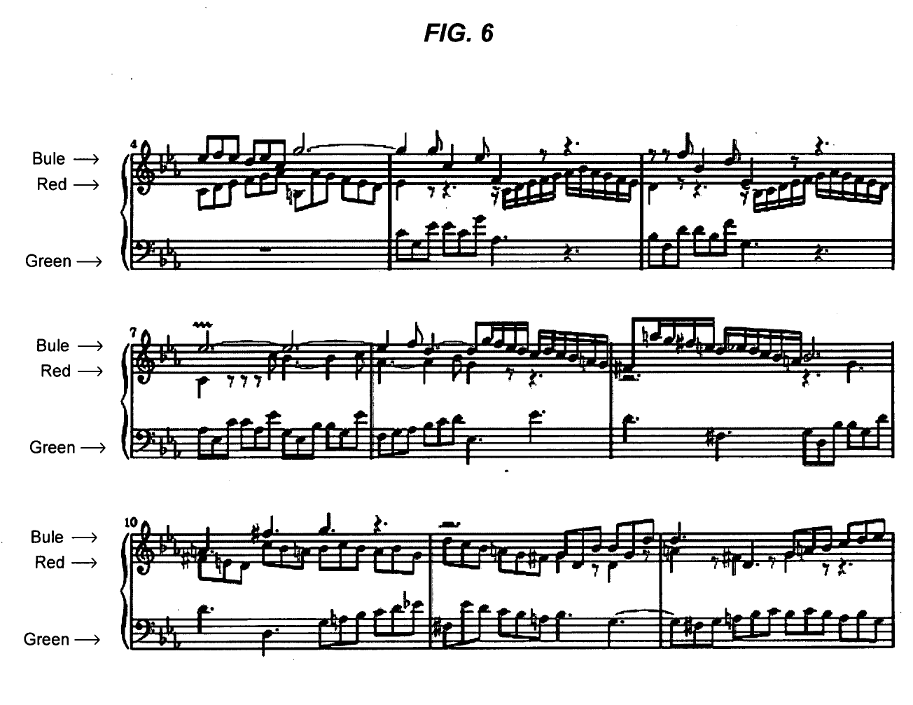

FIG. 6 shows an example of an intelligent digital sheet music format of the system. Multiple voices are represented by different colors. When sheet music is displayed on screen, it is in the regular computer's landscape orientation, or is turned ninety degree and displayed in portrait orientation, which with a laptop or table PC, looks very much like a page in a sheet music book. Music aspects can be deselected so they won't be reflected in the midi roll graph, sheet music, reference data, and audio output. Music aspects' attribute, such as volume for a voice, color or shape for note heads of a voice, and level of fingering details, can also be adjusted and reflected in the midi roll graph, sheet music, reference data, and audio output when appropriate. The system can be extended to that when mouse over or click a music symbol on the sheet music, a straight forward explanations for the music symbol is brought up immediate. These features help users to understand voicing, structure, and foreign symbols in music pieces.

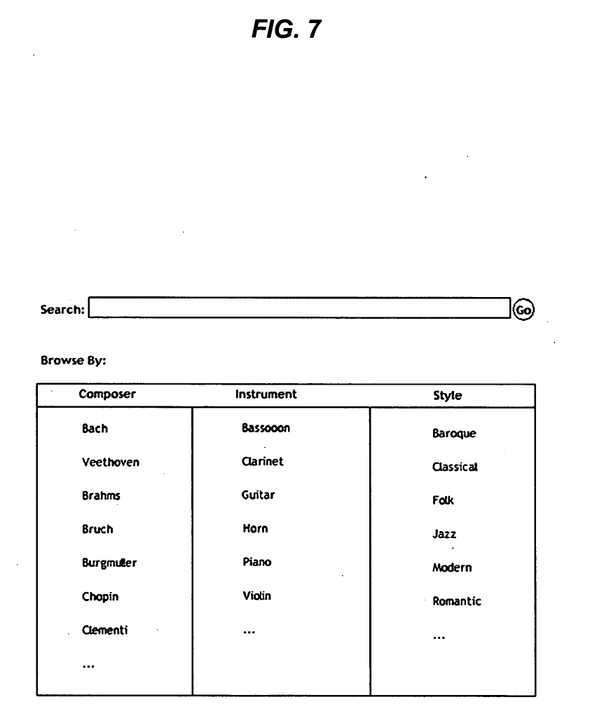

The reference data can be searched via a search interface. FIG. 7 show an example for a text based search. Critical fields of music pieces, such as title, composer, opus number, level, and key are all searchable. A keyword search query will search through these fields. A user can enter a search term in to the search field to search for a particular song or a segment of a song. The search interface can also provide a menu of different search categories, such as composer, instrument and music style, song title, etc.

After all its words are formed, a music piece, which is equivalent to a text file, can be indexed the same way as regular text file. During music search time, the music search key word is formed with similar approach, with each pitch is assigned to a unique value.

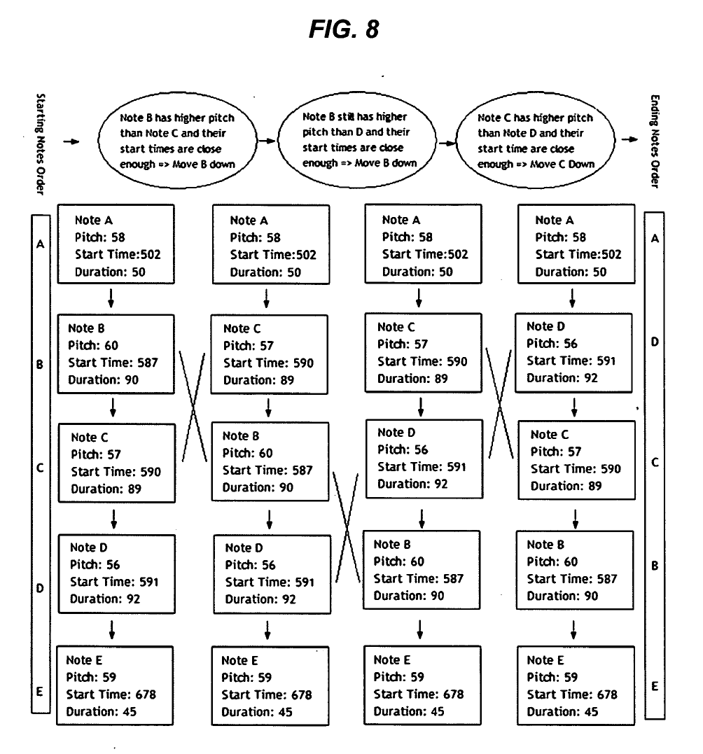

Notes performed during search time are preprocessed so that when the starting time of two notes are very close and their duration are not short compared to the difference between their starting times, the two notes are treated as in one chord or played at the same time. FIG. 8 illustrates an example. When there are more than two notes played at the same time, the middle notes are discarded. All the top notes, including those notes played alone, form one search word. All the bottom notes, including those notes played alone, form another word. Two words can be ORed together for search. Pause in performance during search time are considered as terminator for the music word. Multiple search keywords can be ANDed or ORed together in determining the final search result. To handle the transposition for music, music characters in a music word are deducted of the character value in the word which has the minimum value. So if a word has value of “60 67 57 58 66 62”, it will be transposed to “3 10 0 1 9 5”.

Reference data may be modified on line. If there is any change to be made, the user goes to the content modification page, specifies the location (the measure), the voice, and the aspect (for example, dynamic) of the music to be changed. A short (one measure only) and simple section with the specified aspect of music piece is presented to users for modification and customization. Advanced editing mode can also be selected by users where the full content of the data is presented and available for modification. The modified content is validated again. Once there is no validation error and the user is satisfied with the content of a music piece, it is made live from the activate page and becomes available for general audience. Similarly, any live music piece can also be brought offline from the deactivate page. A live piece may not be modified immediately, but can be extended to be copied and used by users as the base to create different versions of the piece that can be added to the music repository. A collection of multiple music pieces can be created from UI, by entering the collection's title and description, searching and selecting from the music repository, then adding the selected piece to the collection. The collection can be made live for general use as well.

Once the desired music piece is located, the user can view and listen to the desired piece through similar graphics user interface used by the administrator to listen or exam the music content as described earlier.

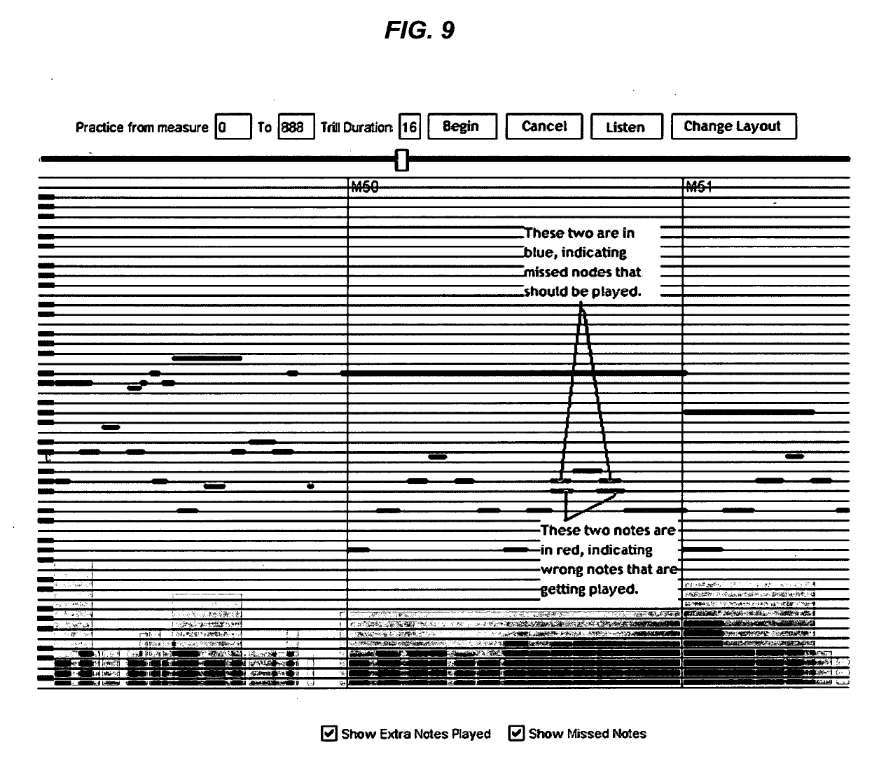

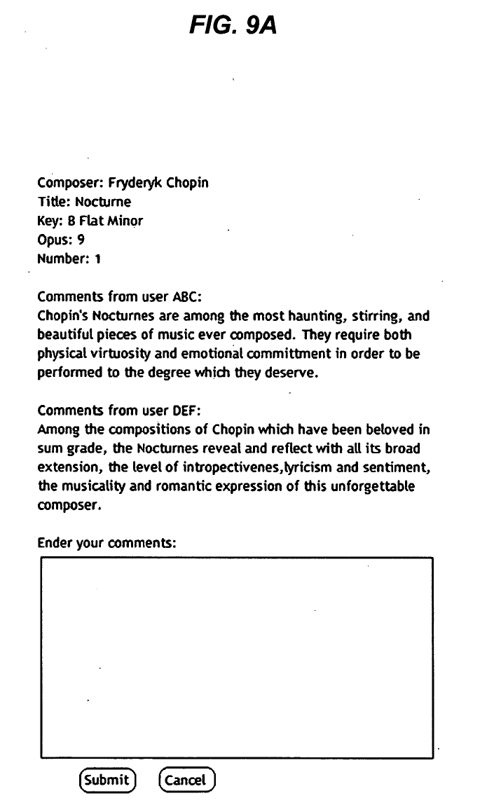

FIG. 9 shows an example in the midi roll formal. The audio output can go to a digital music instrument capable of taking input data, or played as digital audio files on a computer.

FIG. 9 also specifically shows performance data displayed in MIDI roll style. Measures being practiced are specified in the “Practice from measure” and “To” fields. The two fields can be extended to be dropdown lists, with possible values in “from” list ranging from first to last measure of the music piece, and possible values in “to” list starting with “from” value and ending with the last measure. Clicking on the Begin button starts the recording of performance data. The Begin button also turns into End button for ending the recording after clicking the Begin button. Cancel button is for canceling the current recording without having the current performance data archived or analyzed. Listen button is for replaying and listening to the performed data. The output will go to the connected digital music device when it is capable of taking input data, or otherwise to the computer's audio output channel. The horizontal scroll bar is for changing displayed measures quickly with measure goes from small to big when the bar is scrolled from left to right. The bar also indicates the starting position when click on Listen button. M50 and M51 indicate that all notes after the lines are for measure 50 and 51. A yellow bar indicates a note that is played correctly. Most of the notes in FIG. 9 are yellow except the four notes being pointed at. A red bar indicates wrong note is played. A blue bar indicates that a note that should be played but is not. The vertical position of a bar indicates the note's pitch. Horizontal position indicates when the note is started and when the note is stopped. The corresponding green bar at the bottom indicates the volume of the note.

In addition to the standard reference version of the audio data, other users' renditions of the music piece are also available for study and listening. The system can monitor and display other users who are currently playing the same piece real time, and who made their performance publicly available or available to the current user. The user is able to attend the remote users' concert, have the concert data be output again to a local digital music instrument or a computer. A user interface module is provided for users to submit and view detailed analysis, history, recommendation, different approaches to a reference music piece, and to submit and view user comments for performance rendered by users.

FIG. 9A shows summary information about a music piece followed by a discussion thread about the piece.

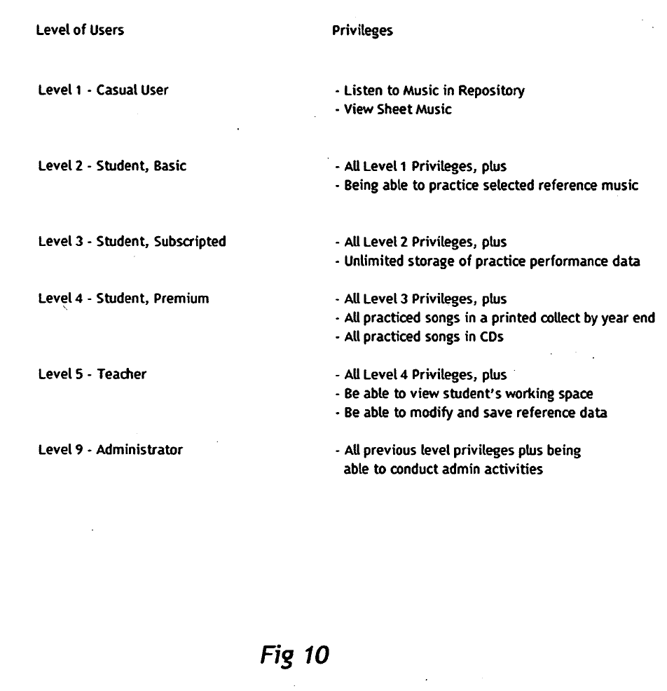

Such a system can be designed to support different levels of users with different features. FIG. 10 shows an example of different levels of users supported by such a system. Certain features can only be accessed by certain levels of users. This multi user level system can be extended to support permissions, roles, and groups to enables users to establish relationships between them, to have features granted to certain permissions, roles, and groups.

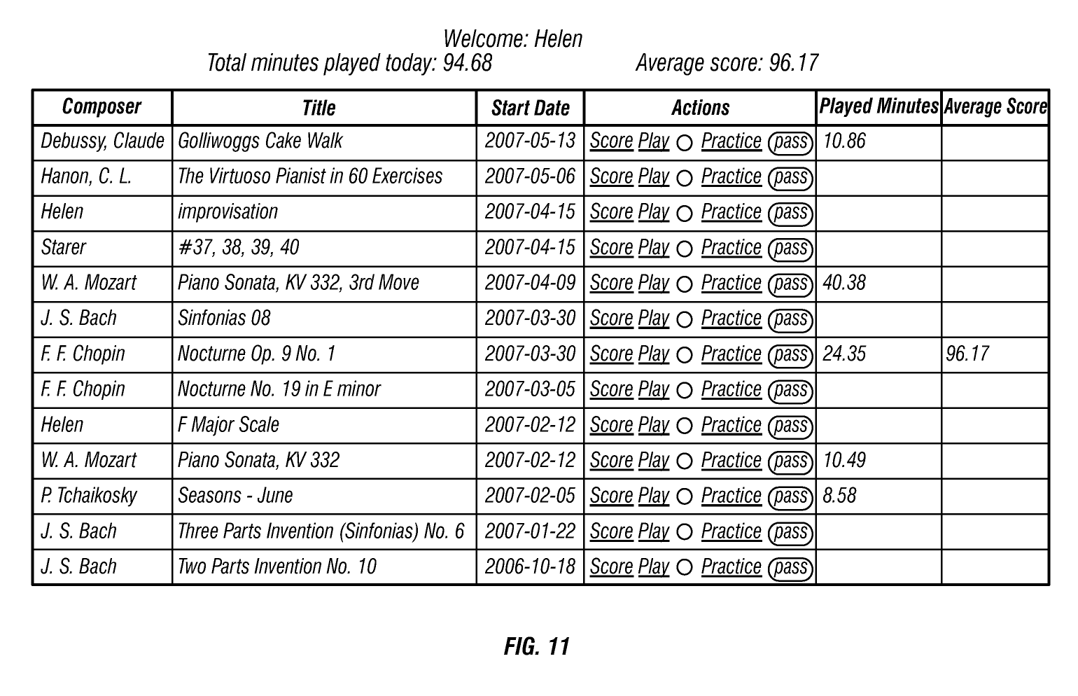

FIG. 11 shows an example of a user workspace UI for this system. This user workspace UI includes the summary information about music pieces being assigned to practice, practice time and score for each of them for the day, which can be extended to changed to a period of time during past to view practice history.

Once the reference music piece is specified and the practice of the piece is started, the system can use a proper sound API, such as a Java sound API, to capture notes that are played by the user on a digital instrument such as a MIDI keyboard or other instrument. The played notes and their volumes are immediately reflected on the client computer screen in the midi roll style. As time passes, midi roll starts scrolling so that latest notes and their volumes are always displayed and earlier notes are scrolled off the screen. The user sees instantly notes he/she played as well as the dynamic shapes. Played data is saved in a temporary local file and then submitted to server and archived as part of the practice history. The next step is to use the comparison layer to analyze user's performance data.

The comparison layer is responsible for executing comparison algorithms between reference data and user generated data. A user's performance can be completely random. For example, the user's performance can be very precise, but can also be erratic and unpredictable. The system can be designed to do a very accurate assessment, because any false alarm in the comparison result may reduce the system's credibility in a user's mind. All specified notes from reference data are packed into a sequence based on time. Notes derived from trill and other ornaments are packed into the same sequence based on time as well. For notes that are in one chord, the lower pitch notes are packed in the sequence first. All notes in performed data are also packed into a time based sequence as well. For performed data, when the starting time of multiple notes are very close and their duration are not very short compared to the difference between their starting times, they will be treated as in one chord or played at the same time thus will have the lower pitch before higher pitch even though the lower pitch might have slightly later actual starting time.

To handle intentional (for example, in the case of rubato) or unintentional slight off sync of multiple voices as well as trill well, multiple full passes of comparison are employed so that big pictures as well as details are both taken into account.

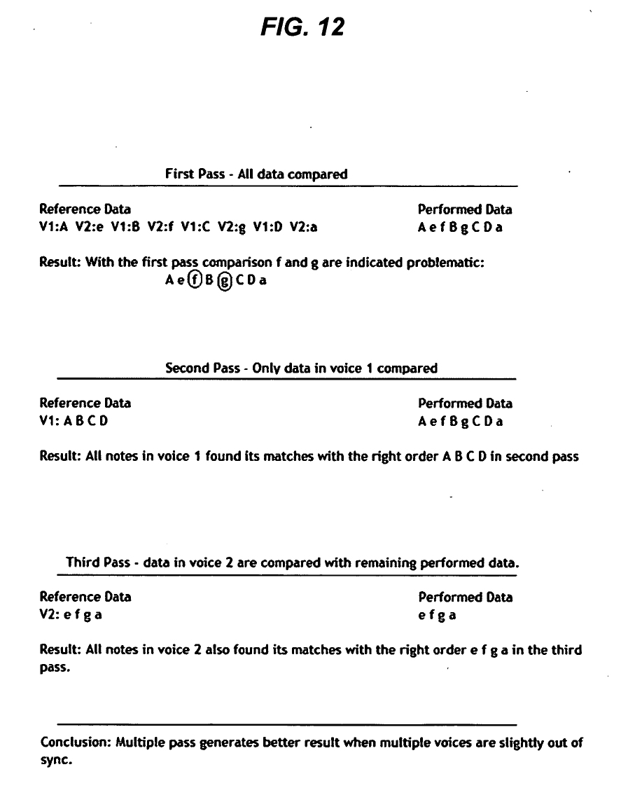

FIG. 12 shows an example of a three-pass comparison. All notes in both reference data and performed data are used during the first pass of comparison where pitch of two notes is the only determining factor when decide if two notes are equal or not. After the first pass, performed notes are assigned with their matching reference notes' start time as rough indicators of which measures the performed notes belong to. Then notes in voice one of reference data are compared to performance data to pick out matches among the two sets with both pitch and approximation of location taken into account, that is two notes are considered equal only when they have the same pitch and they are in same or very close by measures. After that, all matched notes in voice one is taken out of the performed data sequence. Similarly, notes in later voices of reference data are compared to remaining reference data. Equivalent notes, again with both pitch and approximation considered, are taken out of the performed sequence until there is a small enough data set left in the reference data pool. At that point, notes in all remaining reference voices and all remaining performed notes are compared.

The algorithm for the comparison can be implemented by, for example, an O(ND) difference algorithm. This algorithm is used in each comparison pass to generate the most optimal result with the most matches. The system can be designed to take into account the time related musical details, such as chord, tie, tuplet, trill, grace note, polyphonic, and partial measures when packing reference data sequence. Two tied notes can be added to the sequence as one note with the start time equals to the earlier note's start time and duration of the two notes' duration combined. Tuplet's duration is calculated to be exactly what they are supposed to have. Trill is unpacked into multiple short notes. Grace notes have shorter duration and are placed at the right point in the time sequence. As a result of handling these details, the system generates precise reference data sequence that can be used to tracks complicated and difficult music works such as those by Beethoven and Rachmaninoff with several thousands notes played in just few minutes.

In addition to the attention given to play the correct pitch, the length or duration played for notes are usually critical while interpreting some music pieces such as those from Bach. So users can specify if they want the note duration be considered during the comparison when consider if two notes are the same or not. Tempo for reference data is defined. Tempo for performed data at any point can be derived from a note's start time, its next note's start time, and the note's intended duration.

For example, if the defined reference tempo is 120 for quarter notes, the current performed note's start time is 100.5 second, it's next note start time is 101 second, the current note is a quarter note, then the current performed note's temp is 60/(101-100.5), which is also 120 per quarter note. This is how performed data's tempo is calculated and evaluated. Reference data's dynamic information is defined. Performed data's dynamic strength is calculated based on the current note's strength, the loudest note's strength, and the weakest note's strength. Performed note's dynamics is evaluated against its desired dynamics. Performed note's rhythmic grade is evaluated based on the current note's position in a measure, the current time signature, and the current note's relative strength compared to other notes in the same measure. Pedal grade for performed data is determined by the actual pedal down and up time compared to the desired down and up time specified in reference data.

Users can configure the system to check against only few areas first. But once a user is very fluent with a music piece and turns on all checking, every misalignment of tempo, every missed dynamic change, and every inappropriate use of pedal is pointed out and displayed in the midi roll chart, tempo chart, dynamic chart, or in sheet music.

The system can be designed to track measures with most mistakes as well as areas with lowest grade. It recommends to users in a non-intrusive manner the measure where more practice is needed and areas that need more attention. These text based advices are displayed along with the midi roll. Clicking on a recommendation, which is usually associated with a specific measure, will make the midi roll go to the location of the music piece where the recommendation is given with error highlighted. In addition, with previous performance statistics and reference data available, with the fast comparison speed that can track users' current playing location, the system can be extended to do real time practice coaching, reminding users of upcoming dynamic, tempo, phrasing, pedal, and other changes plus previously made mistakes.

The practice companion system can use adaptive approach to let a user feel in control. Commonly seen music systems display and scroll reference sheet music at a monotonous speed. They display few measures of a music piece ahead of time while the player struggles to catch up with or match the machine's speed. Although being able to play at a preset speed is necessary, this type of machine in control approach is restrictive that it takes away the fun and meaning of music playing, which is to be able to express yourself, to express your own feeling through your playing at a pace you feel comfortable with. It is considered important to let the player feel in control during music playing. The practice companion system is highly adaptive, that is the user can play and express with the pace and the manner that user is comfort with. The system does its best at recognizing what the user intends to play. The player is in full control, not the computer. The system points out deviations from the standard data in a non-intrusive manner.

The comparison is based on an efficient algorithm, an O(ND) difference algorithm, in order to generate result as fast as it can. There is no performance problem with music pieces longer than ten minutes with thousands of notes played.

The reference data contains artistic intentions marked by the composers. In additions, through the content modification user interface mentioned earlier, teachers can alternate the standard reference version to reflect their interpretation of the music, and keep the version as a private reference version for their students or other audience as well.

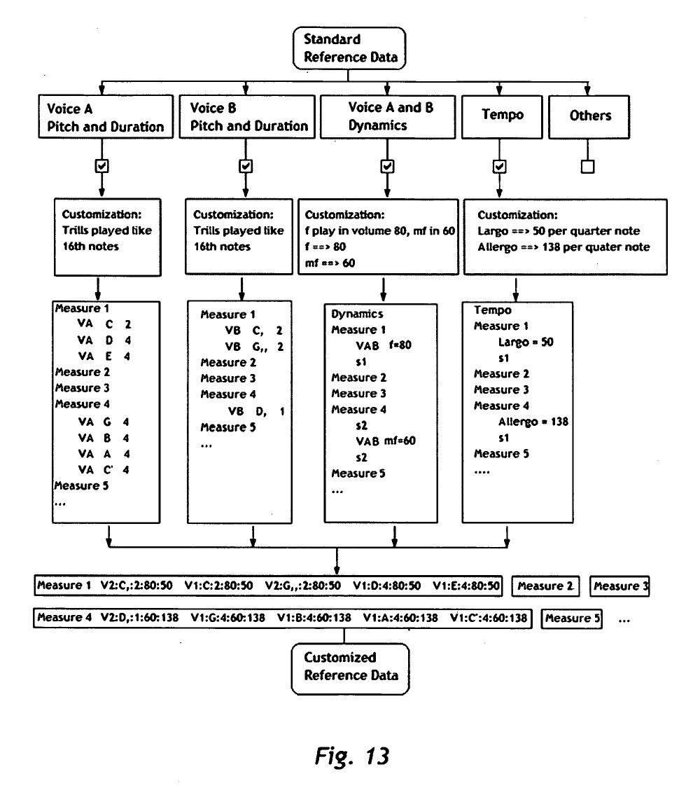

User can also customize reference data as shown in FIG. 13. FIG. 13 shows how Customized Reference Data, which reflects each user's own interpretation of music, is derived from the Standard Reference Data, which precisely describes composer's intension. Different music aspects of standard reference data are selectively included into the formation of customized reference data first. Then user can set user's own interpretation as set of customization parameters. In the end, the Customized Reference Data is packed into a sequence to be used to analyze user's performance data. In FIG. 13, VA stands for voice A, VB stands for voice B, and VAB stands for voice A and B. C, D, E, F, G, A, B stands for note pitch. 4, 2, and 1 stands for quarter note, half note, and whole note. The final customized reference data entry has Voice Number:Note Pitch:Note Duration:Dynamics Value:Tempo Value in it. So V1:C:2:80:50 represents a note in voice 1, with pitch C, half note, with strength 80, and tempo 50.

In addition, new standard reference music data can be added to the music repository by experience users or the system administrator so there is no need to upgrade software or download more reference data. This open approach adds flexibility and usability to the system.

Many digital music instruments support auto-replay. Although auto-replayed data may not be recorded, the system can be extended to exam and compare the current recorded data against previous recordings for valid variations. Nearly identical repetitions, such as auto-replayed or slight modification of previous recordings, where multiple consecutive notes' relative starting time or played duration are the same to high precision such as a thousandth of a second, which is almost impossible to be done by users, can be flagged as invalid performance data. The system can also look for gaps embedded in the played note sequence where there is a long duration of time relative to the played tempo, such as over ten seconds of silence between the previous and next played notes for tempo 120 with quarter notes. These gaps can be taken out of total played time. Thy can also be flagged out as mistakes and are deducted from final grades.

The system supports analyzing multiple performed versions against one reference version in ordered to point out repeated mistakes, which usually represent true oversights, and distinguish them from accidental mistakes, which usually get corrected by users automatically without flagging them. A vector is created with each element in the vector contains the error position, the type of error (missed note, extra note, note too short, etc.), the note involved, and the error count. When an error is added to the vector, it is checked against errors already in the vector. If an error at the same location, with the same type and note already exists, the count will be increased by one. Otherwise the error is considered new and is added to the vector with count set to one. At the end of this process, errors with high count numbers are considered as repeated mistakes that need most attention from the user.

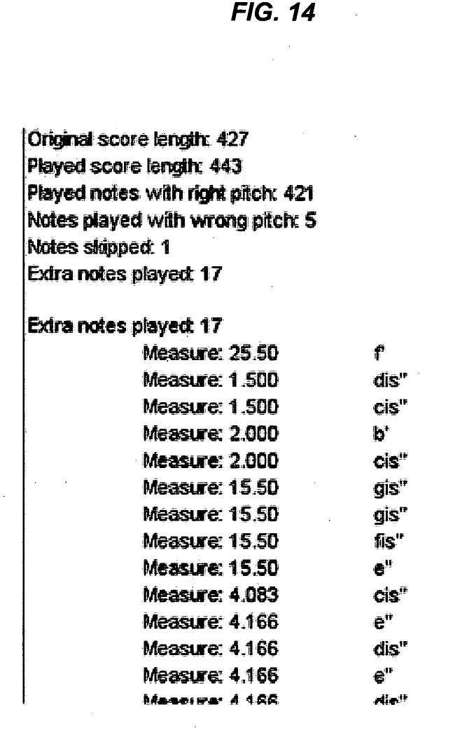

FIG. 14 shows the text summary of an analysis result.

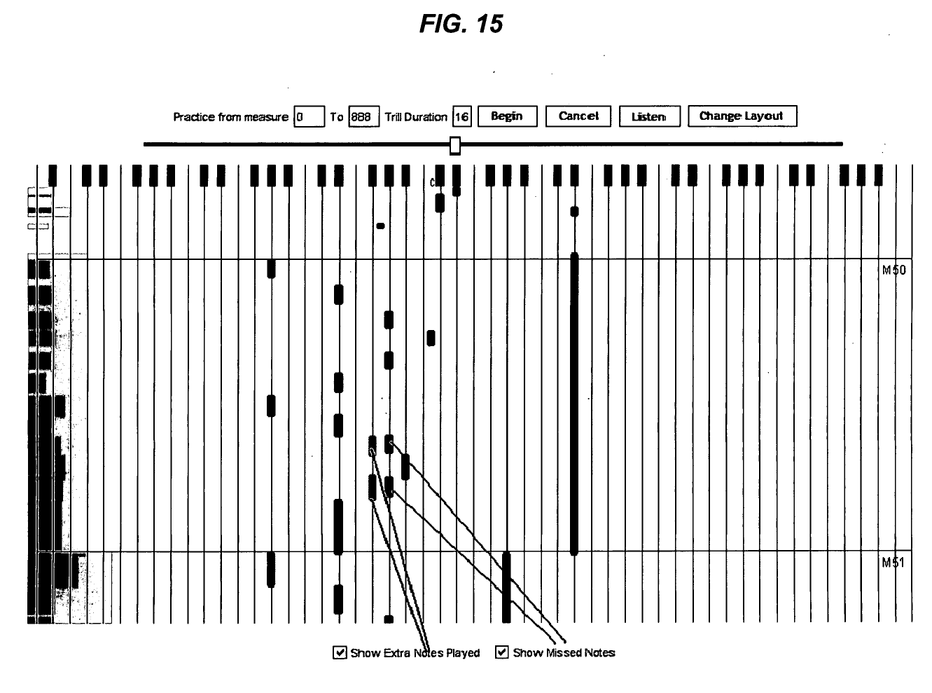

FIG. 15 shows the midi roll version of analysis result. The graph is similar to FIG. 9 but is laid out vertically.

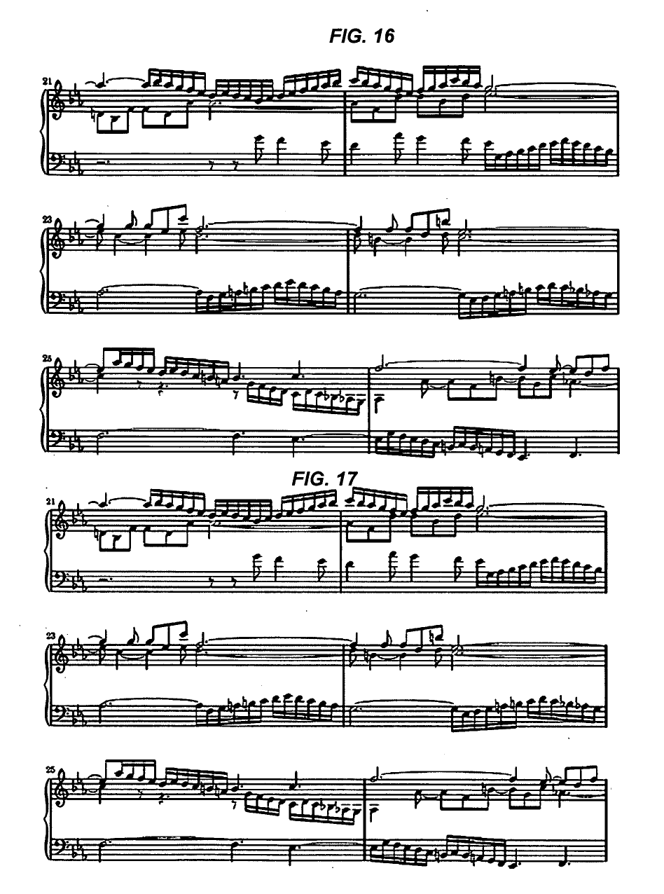

FIG. 16 and FIG. 17 show sheet music version of analysis result. FIG. 16 shows errors that were made in sheet music format. Blue notes are not played, red notes are played wrong. FIG. 17 shows wrong/missing notes and notes played with right-pitch but wrong duration (too long in magenta, too shot in light blue).

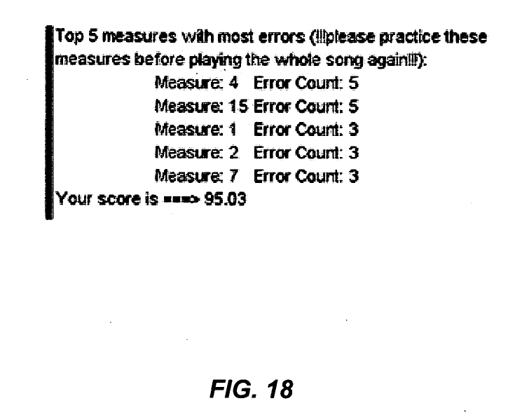

FIG. 18 shows text based simple practice suggestion.

In addition to visually viewing the practice result, with the starting time of measures embedded in the reference data that can be used to locate a measure in reference data, and with the matching performed note assigned with measure information from reference data after comparison, the system supports audio comparison by let the user listen to reference data and the user's own performance data from a specified measure. This is useful while dealing with difficult, error prone music passages. The system can be extended to support playing both reference data and performed data at slower speed. The system can also be extended to supports practicing at lower speed but speed it up during playback time so users can hear and anticipate what their playing eventually sounds like. Both speed up and slow down can be achieved by multiplying a fixed ratio, smaller than 1 for the speed up case, bigger than 1 for the slow down case, to all listened to notes' start time and duration.

The system shows with a local digital music instrument what exactly was played by users, teachers, or masters from a remote location in near real time with minimum delay. The one to one connection is established between the audience and the performer through network socket programming. Performance data is acquired by the computer connected to the performance instrument, sent over to the audience computer, played to the audience's digital music instrument. When the audience instrument is a player instrument, the audience can observe the movement of the instrument's parts as if it is being played by the remote user. In case a player instrument is not available, the audio part of performance can still be sent to and heard from the local digital music instrument. There is no requirement for participants to physically meet each other. The performance data is also uploaded to and stored in the server, so it can be analyzed, replayed just like any other user data. There is no formal teacher-student relationship for the case when a student just needs occasional advices. Teachers' time can be purchased or bid online. This gives users access to great teachers as well as those at affordable price. Remote master class and performance are also observed and enjoyed by wide audience without physically going to the class location. In this case, master class data is multicast through network and the audience computer signs up to receive data broadcasted by the performance computer's IP address.

In another aspect, the system can be designed to support functions of a regular metronome by generating and sending to the digital instrument a MIDI sequence with a fixed gap between two events. It can also be achieved by play an audio file on the computer at specified intervals. A unique intermittent metronome can be implemented, where the sound of the metronome is alternatively turned on and off automatically for users who want to practice their own control of tempos, yet still want to be checked intermittently to see if they are deviating away from the correct tempo or not. The duration for metronome on and off time is defaulted or user configured. During the metronome on period, metronome sound is played as described above for regular metronome. When the on period expires, no metronome sound is played for the duration specified for “off” period. The intermittent metronome can also be extended to be turned on only when users are off the tempo. The system can also be extended to support the metronome to be adaptive to the reference music's change of tempo and time signature, and adaptive to individual's preset change of tempo.

The system can use the comparison module to estimate user's current performance location, find the desired tempo for the current location from the reference data or user specification, and use the desired tempo at the current location to calculate metronome sound intervals. The system can also calculate the current performed location's tempo (see formula for calculating tempo earlier), compare it to the desired tempo, play metronome sound only when the two tempos have enough difference between them. Special attention can be given to time signature and rhythm so that it reminds user which beats should be emphasized.

The volume and sound of the metronome click can also be adjusted so that the first beat of a 6/8 piece will be the loudest or most obvious, the 4th beat will be the second most obvious, and remaining be less obvious. Similar approach can be used to handle pieces with other time signatures.

There are two use cases where rhythmic practice is need for students. For a rhythmically complicated piece, teachers sometimes ask students to focusing on practicing the rhythm for the piece first. Another use case is a user who is weak when it comes to rhythmic control and was assigned to do more rhythmic practice by the teacher. For the first case, the rhythmically complicated piece itself becomes the base of rhythmic practicing data. To find data for the second use case, statistic data is created for each, piece in the reference data repository regarding the percent of occurrence of whole notes, half notes, quarter notes, eighth notes, sixteenth notes, and on and on. When needed, a music piece with high percentage of 16th notes and 6/8 time signature becomes a choice available for a user who needs rhythmic training for 16th note with 6/8 time signature. Music pieces with too many voices, especially when some voices are intermittent or have few notes are not considered as good candidate to be used in rhythmic practice.

Several rules are followed to turn a regular piece to a rhythmic practicing piece. Multiple notes in a chord in each voice are turned into one note. For the second use case above, a music piece that is long or has time signature changes is broken up into sections either based on the time signature change or after every two hundred notes (after collapsing a chord into one note). Each section is considered as one candidate for rhythmic practicing. All notes in each voice are changed to have one unique pitch, which is different from other voices. Dynamics, phrasing, articulation information are ignored. Sheet music suited for rhythmic practicing, which has all above changes, is generated.

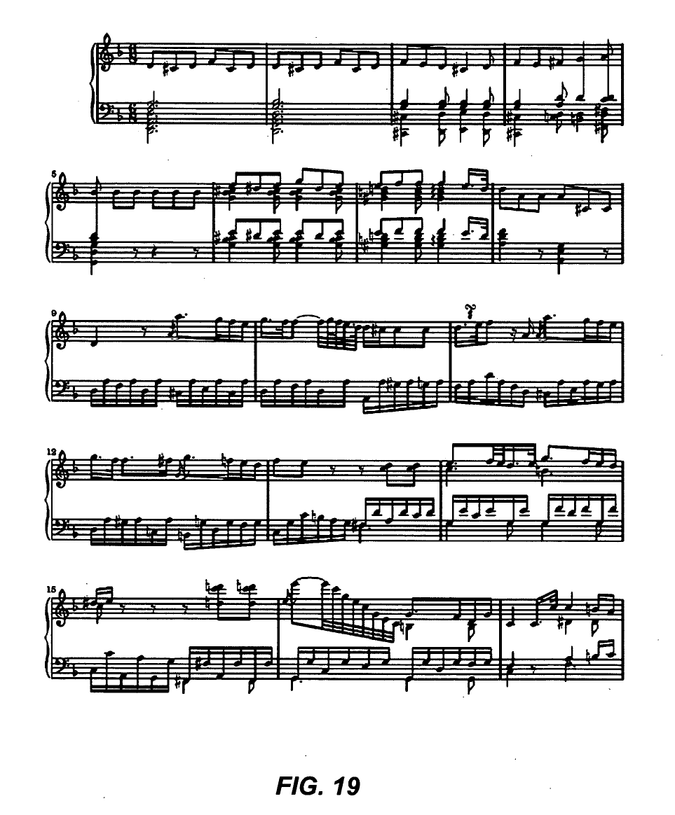

FIG. 19 shows a music piece with relatively complex rhythms.

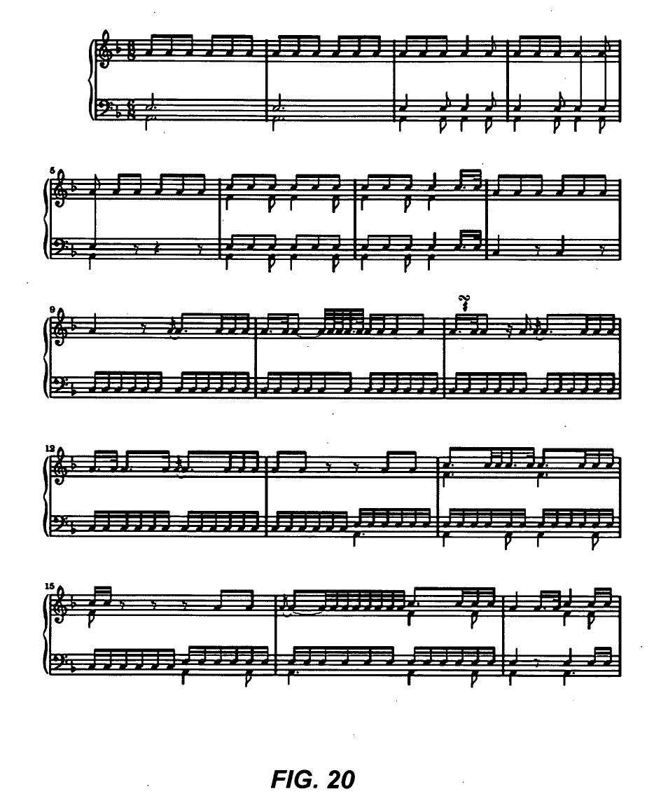

FIG. 20 shows the same piece in FIG. 20 being turned into a piece for rhythmic practice purpose.

In the rhythmic practicing mode, the notes' strength, starting time, and duration are analyzed, graded, and are required to have higher accuracy. After the comparison stage when a performed note already matched up with its reference note, the two notes' start time and duration are examined again. A performed note with start time and/or duration significantly different from its reference note's start time and/or duration will be flagged as problematic and reduces final score. Performed notes are also evaluated measure by measure to see if the right beats have the emphasis or not. For a measure with 6/8 time signature, the first beat must be strongest and forth beat second strongest. Otherwise it is considered rhythmically wrong. Similar approach can be used to handle pieces with other time signatures.

The system can easily be used to support basic scale, chord, and arpeggio practicing by having them entered as reference data. They can also be modified with desired tempo and dynamic changes. It can be easily used to practice hands separation in piano playing. For example, the right hand plays scale in crescendo and decrescendo while left hand steps in after each right hand note and stays soft through out. All that need to be done is define the practice data and add it to the reference data repository and the system from then on can be used to grade this type of practice.

In stead of requiring users to specify pieces being practiced, the system can be extended to support free practice mode, so students can practice any pieces desired without specifying them, the system will automatically record every single note played, identify the songs played through the indexing/searching system, grade and analyze them, and also indicate breaks took between all plays as well as calculate total time played.

The system can be used to support accompaniment by playing accompaniment data from reference or user data repository, or from remote performance.

The system can also be extended to automatically enhance performed data by removing identified extra notes in the performance data and adding missed reference data into the performed data, by setting performed note's strength to the desired value specified in the reference note, by removing unwanted gap in the practice data and adjusting a note start time and duration when tempo around it is off.

The system can be extended to ignore specific error in specific measure by mouse over the error, bring up a context sensitive-menu at that position, and pick to ignore the error at that specific point, or ignore the same type of errors through out the performance.

The system can be further extended to combine tedious practice/drill with games and animations.

While music content is displayed in sheet music mode, sheet music page can be extended to be “flipped” by using an arrow key, by voice control, or by automatically detecting a player progress and “flipping” the page at the right time.

Instead of using buttons in the web based user interface to control starting, ending, canceling recording of the practice and other functions, special combinations of notes that usually do not appear in a music piece can be used as the hot keys to issue those commands. An example will be using three consecutive play of the lowest note on the instrument to mark the beginning of practice. Play the same sequence will end the practice. Play the highest note on the instrument three times will cancel the practice.

The system can be implemented as server based software solution or as installed software product, or combination of both, for example, the repository and search services on server computer, scoring module, some conversion modules and user interface on client computer. Some modules can be implemented using hardware solution as either add-on hardware modules to the music instrument or as OEM modules such as a processor chip, LCD touch screen, handheld device, or tablet PC.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few embodiments are disclosed. However, it is understood that variations and enhancements may be made.

What is claimed is:

1. A computer-implemented method for digital music, comprising:
dividing information in a music piece into a plurality of music aspects that comprise note pitch and duration for one or more voices, tempo, dynamics, phrasing, articulation, and fingering of the music piece;
obtaining digital data of the music aspects of the music piece, based on at least one of (1) definitions and intentions of a composer of the music piece and (2) interpretations and modifications of the music piece by a selected person, to generate reference data for the music piece;
obtaining performed data of a player playing the music piece on a digital music instrument;
comparing the performed data to the reference data to produce a comparison result; and
producing a digital output representing the comparison result.

2. The method as in claim 1, comprising:
configuring a format of the reference data to allow for editing of the reference data by a user to include a user modification, interpretation or comment on the music piece.

3. The method as in claim 1, comprising:
providing a plurality of output options for the digital output that include at least one audible digital data format, a digital sheet music format coded to represent the comparison result, a text format, and a MIDI roll style format coded to show the comparison result.

4. The method as in claim 1, comprising:
configuring the comparing the performed data to the reference data to be adaptive to playing of the player to produce the comparison result after the player completes the playing.

5. The method as in claim 1, comprising:
providing a user interface to allow the player to select the music aspects to be included in the comparison result.

6. The method as in claim 1, comprising:
providing a database to store the reference data for multiple music pieces; and
providing a search interface to allow a user to search for the reference data in the database for a user-selected music piece.

7. The method as in claim 6, comprising:
providing at least one computer server on a computer network to store the database of the reference data and to store the performed data of one or more users; and
using the at least one computer server to perform the comparison of the performed data to the reference data to produce the comparison result.

8. The method as in claim 1, comprising:
providing rhythm data of the music piece in the reference data; and
including the rhythm data of the music piece in the comparison result.

9. The method as in claim 1, comprising:
providing a metronome generator to produce a digital metronome signal to a user to produce an audio signal to the user that produces an intermittent metronome.

10. The method as in claim 9, comprising:
providing a control to the user to allow the user to control the interval of the intermittent metronome.

11. A digital music system, comprising:
a reference database to store digital reference data of music pieces, wherein the reference data for each music piece comprises data on a plurality of music aspects that comprise note pitch and duration for one or more voices, tempo, dynamics, phrasing, articulation, and fingering of the music piece;
a user database to store performed data of one or more players playing music pieces on digital music instruments; and
a comparison module that compares performed data of a player playing a player-selected music piece to corresponding reference data for the player-selected music piece to produce a comparison result in form of a digital output representing the comparison result.

12. The system as in claim 11, comprising:
an editing mechanism to allow for editing of the reference data by a user to include a user modification, interpretation or comment on the music piece.

13. The system as in claim 11, wherein:
the comparison module includes a plurality of output options for the digital output that include at least one audible digital data format, a digital sheet music format coded to represent the comparison result, a text format, and a MIDI roll style format coded to show the comparison result.

14. The system as in claim 11, wherein:
the comparison module adapts the comparing the performed data to the reference data to the playing of the player to produce the comparison result after the player completes the playing.

15. A digital music system, comprising:
means for storing digital reference data of music pieces, wherein the reference data for each music piece comprises data on a plurality of music aspects that comprise note pitch and duration for one or more voices, tempo, dynamics, phrasing, articulation, and fingering of the music piece;
means for storing performed data of one or more players playing music pieces on digital music instruments; and
means for comparing performed data of a player playing a player-selected music piece to corresponding reference data for the player-selected music piece to produce a comparison result in form of a digital output representing the comparison result.
